(19) United States
(12) Patent Application Publication
(10) Pub. No.: US 2013/0329607 A1
(43) Pub. Date: Dec. 12, 2013

(54) TRADING ROOM VOICE ROUTING SOLUTION

(71) Applicant: INFINET FINANCIAL SYSTEMS, NEW YORK, NY (US)

(72) Inventor: HUW RICHARD WILLIAMS, NEW YORK, NY (US)

(21) Appl. No.: 13/913,267

(22) Filed: Jun. 7, 2013

Related U.S. Application Data
(60) Provisional application No. 61/656,855, filed on Jun. 7, 2012.

(51) Int. Cl. H04L 29/06

(52) U.S. Cl. CPC H04L 65/1096
USPC 370/260

(57) ABSTRACT

A conferencing system may provide a data stream routing solution integrating data streams of different formats for compatibility during a conference. Endpoints using different communications devices may participate in the conference. A protocol may be applied to data streams participating in the conference so each endpoint may recognize the contents of the data stream. The endpoints may be connected in a peer-to-peer network so that data streams may be distributed to each endpoint rather than relying on a bridge. Signal mixing of data streams may be performed to provide improved quality to the signals transmitted be each endpoint.

### CROSS-REFERENCE TO RELATED APPLICATIONS

This application claims benefit under 35 U.S.C. §119(e) of U.S. Provisional Application having No. 61/656,855 filed Jun. 7, 2012, which is hereby incorporated by reference herein in its entirety.

### BACKGROUND

In fast paced communications environments, many parties to a conference, for example, a teleconference may need to be connected. Typically a bridge may be used to connect different participants to a call. However, the bridge is typically configured to one type of device for connecting multiple parties. However, not all participants may wish to use the same type of device to connect. The origination or type of each participant's connection may be dissimilar to other participants' calls and thus may cause incompatibility which may prevent participants from attending the same conference. Incompatibility may become more of an issue with different communication devices being available. For example, some participants may want to connect using a telephone while other participants may want to connect using a computing device that can handle voice, video, and document transferring capabilities. With each device using a different communication protocol, conventional systems may not be able to process and manage incoming communication data for every participant. This may be particularly important in high speed conference settings such as a commodity trading room where it may be critical for participants to hear and see data quickly to make rapid decisions.

In addition, conventional conferencing systems that rely on a bridge may suffer from unreliable connections. For example, when the bridge fails, the conference as a whole may be dropped and thus significant time and effort may be used in re-connecting everyone. In a fast paced environment (for example, the trading room scenario described above), this may lead to disastrous financial losses.

As may be seen, there is a need for a system that can reliably integrate multiple communication data streams into a single conference.

### SUMMARY OF THE INVENTION

In one aspect of the present invention, a conferencing system comprises a plurality of endpoints connected in a peer-to-peer relationship. A mixer may be connected to the plurality of endpoints. The mixer may be configured to mix data streams from a plurality of participants in a conference. A processing device may be in at least one of the plurality of endpoints. The processing device may be configured to convert data streams from the plurality of endpoints into a real transport protocol.

In another aspect of the present invention, a conferencing system comprises a plurality of terminals connected via a mesh network. A gateway server may be coupled to the plurality of terminals and to a device connected into the network through a public switched telephone network (PSTN). A processor may be configured to convert data from the device into a data stream format readable by the plurality of terminals.

In another aspect of the present invention, a computer program product for connecting endpoints using a plurality of data stream formats into a conference, the computer program product comprising a non-transitory computer readable storage medium having program code embodied therewith, the program code readable/executable by a processing device to: identify endpoints corresponding to participants on the conference; identify a data format corresponding to respective devices used at the endpoints; apply a data common protocol to data streams from each of the endpoints; and distribute the data streams to respective endpoints through a mesh network connection of the endpoints.

These and other features, aspects and advantages of the present invention will become better understood with reference to the following drawings, description and claims.

### BRIEF DESCRIPTION OF THE DRAWINGS

FIG. 1 is a schematic diagram of a system for conferencing according to an exemplary embodiment of the present invention;

FIG. 2 is a schematic diagram of data stream flows in an incoming call using the system of FIG. 1;

FIG. 3 is a schematic diagram of data stream flows in an outgoing call using the system of FIG. 1; and

FIG. 4 is a block diagram of an exemplary terminal used in the system of FIG. 1.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention generally provides an adaptive trading platform (ATP) system for providing high-speed conference connections between a plurality of endpoints, for example, in a trading room environment. In exemplary embodiments, a peer-to-peer network connection may be employed bypassing the need for a dedicated conference bridge device. In some embodiments, multiple parties may be on any one conference that is streaming, for example, multimedia data that use both audio and video data. In some embodiments, the system may be configured to allow one party to be connected to multiple calls simultaneously. The endpoints of the system may store software configured to allow the endpoints to initiate, participate, and manage a conference from individual endpoint stations. The endpoints may be configured to manage distributed signal mixing of a conference call where endpoints may process data streams in the call using signal mixing software. A participant at an endpoint, (for example a trader's turret) may have the capability to teleconference and watch a streaming video of a report or view document data while executing trades from the same terminal. In some embodiments, multiple signal mixers may provide redundant mixed data streams for every endpoint on the call thus providing a failsafe mechanism in the event a data stream in the call is dropped or becomes corrupted along its data path through the network.

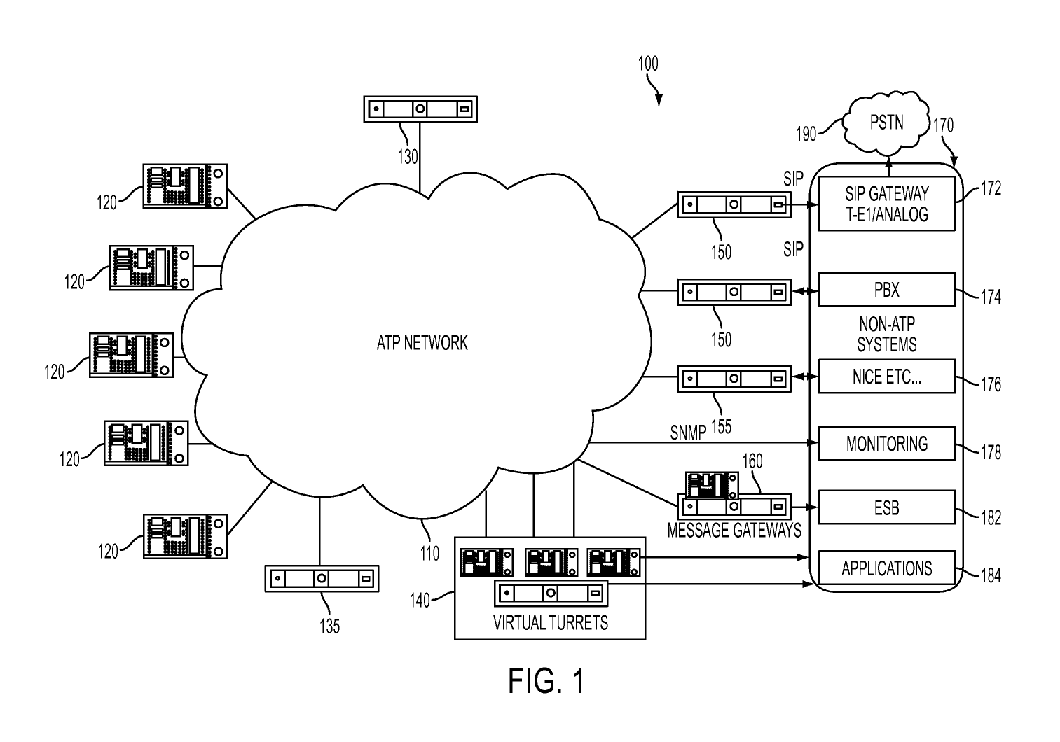

Referring now to FIG. 1, a system 100 for conferencing is shown according to an exemplary embodiment of the present invention. The system 100 may include end points (for example, phones (not shown), turrets or terminals 120, voice over IP enabled (VoIP) gateways 150; 155; 160, and conference units (not shown)) that may be geographically dispersed with all endpoints connected to the network 110 always being available to each other.

In some embodiments, the conference may be a teleconference with at least some of the endpoints being connected to a telephone. In some embodiments, the conference may be a video conference. In some embodiments, participants may use multimedia data streams to communicate and share information. In some embodiments, a mix of audio, video, or multimedia data streams may be used to connect participants. The computer readable programs and computer executable instructions may use an IP telephony protocol, for example, a session initiation protocol (SIP). Data entering the network 110 from the public switched telephone network (PSTN) 190 may be processed by the SIP (or other similar voice protocol) compatible computer readable programs and computer executable instructions for use by the terminals 120 and other devices connected to the network 100 as described below in teleconferencing applications.

Data being transferred through the network 110 may use the real-time transport protocol (RTP). In some embodiments, the system 100 may be configured to process ATP data through a partially meshed unicast switched network 110. The system 100 may include a user solution that may provide a range of specific user interfaces for connecting to the network 110. A management platform may allow configuration of positional and line equipment prior to establishing connections.

An application platform may allow linkage to third party and proprietary applications to interface with, and add specific value to the system 100. For example, the network 110 may be connected to the PSTN 190 through ATP gateways 150, a voice recording gateway 155 and message gateways 160. A bank 170 of data exchange modules (172; 174; 176; 178; 182; 184) may translate and carry data from respective interfaces with the network 110 to the PSTN 190. While “SIP” protocol is shown associated with gateway servers 150, it will be understood that the associated computer readable programs and computer executable instructions including the audio mixer modules may be resident on the other devices connected to the network 110. On the gateways 150, 155, 160, DS1 interfaces may support T1/E1/J1 via a software switch, and there may be enough digital signaling processor power to support conferencing, echo cancellation, compression, and wideband CODEC's.

In an exemplary embodiment, the terminals 120 may be connected together in a peer-to-peer fashion. Thus, signals may be sent directly from and received directly by each of the terminals 120 participating in a conference. It may be appreciated that by using a peer-to-peer connection, the transmission of data streams corresponding to a conference may be distributed rather than relying on a centralized bridge where failure may bring an entire call to an abrupt end. As may be appreciated, by incorporating the software within each endpoint in the peer-to-peer arrangement, a mesh network of endpoints with higher levels of conference participant scalability may be accomplished over conventional bridged teleconferences. In addition, unlike conventional teleconference systems, the system 100 may connect participants using different telecommunications formats (for example, internet protocol (IP), private branch exchange (PBX), and squawk box systems) which may be typically otherwise incompatible.

When bringing a terminal 120 (or other endpoint, for example a virtualized terminal 140 or a call participant originating externally from the PSTN 190) into the system 100, the terminal 120 may be connected to a configuration server 130. The configuration server 130 may store computer readable programs and data, and computer executable instructions which may be loaded into the terminal 120 allowing it to communicate with other terminals 120 or other endpoints. For data streams originating from the PSTN 190, the gateways 150 may translate the data streams using the SIP protocol for compatibility within the network 110.

In some embodiments, the system 100 may include a morning call server 135, for example, in applications where the system 100 is used for large scale trading room conferencing. The morning call server 135 may employ both a two-way transmission and a one-way broadcast or multi-cast transmission of audio data to the terminals 120.

In an exemplary embodiment, the system 100 may include virtualized terminals 140. The virtualized terminals 140 may be software applications run on an electronic platform that is not a dedicated terminal 120. For example, the virtualized terminals 140 may be programs run on a PC, a mobile phone, a tablet or other computing device with a user interface. The terminals 120 may be configured to communicate with the virtualized terminals 140 as though the virtualized terminals 140 were terminals 120.

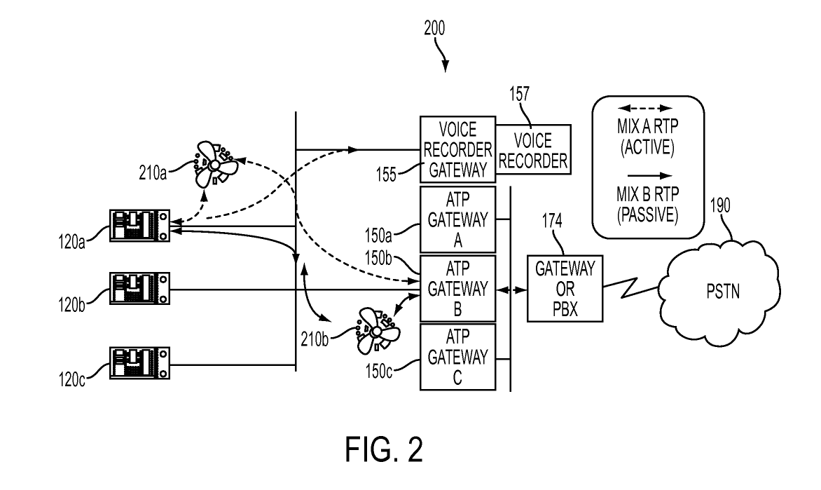

Referring now to FIG. 2, a schematic showing directionality of data streams in a conference system 200 is shown according to an exemplary embodiment of the present invention. In an exemplary embodiment, the conference system 200 may provide redundant mixing and recording of data streams for an incoming call. The conference system 200 may use features of the system 100 (FIG. 1). In the exemplary embodiment shown, three terminals 120a, 120b, and 120c (referred to in general as terminals 120) may be available for a conference. Data streams traveling between the terminals 120 and the PSTN 190 may be processed through one or more gateways 150a, 150b, 150c (referred to in general as gateways 150) and a PBX gateway 174. In the schematic shown, a primary data stream being processed may be represented by lighter shaded arrows and a secondary (or redundant) data stream being processed may be represented by darker shaded arrows.

An incoming conference call may originate from any endpoint, for example, one of the terminals 120a, 120b, 120c, or from, for example, the PSTN 190. In an exemplary embodiment of an incoming call, the terminal 120a may participate and exchange data streams with other participants (not shown) through one of the gateways 150. In an exemplary embodiment, the gateway 150b may be designated as handling a particular conference. While only one gateway 150b is shown as handling conference data streams, it will be understood that in some embodiments, the conference may be handed over to one of the other two gateways 150a or 150c. The conference system 200 may send a inquiry message to any available mixers 210 for capacity to mix a conference. Data streams mixed by mixers 210 may use a Real-Time Transport (RTP) protocol. In an exemplary embodiment, primary data streams received by and transmitted by the terminal 120a may be mixed by a primary mixer 210a. In an exemplary embodiment, secondary data streams from the terminal 120a may be simultaneously mixed by a back-up mixer 210b. Both processed primary and secondary data streams may be provided to the gateway 150, however, the secondary data stream may be muted (streamed in passive mode) until needed, for example, due to loss of availability of the mixed primary data stream. Data streams provided by the terminal 120a may be sent to the voice recorder gateway 155 and stored in a voice recorder 157 for future playback.

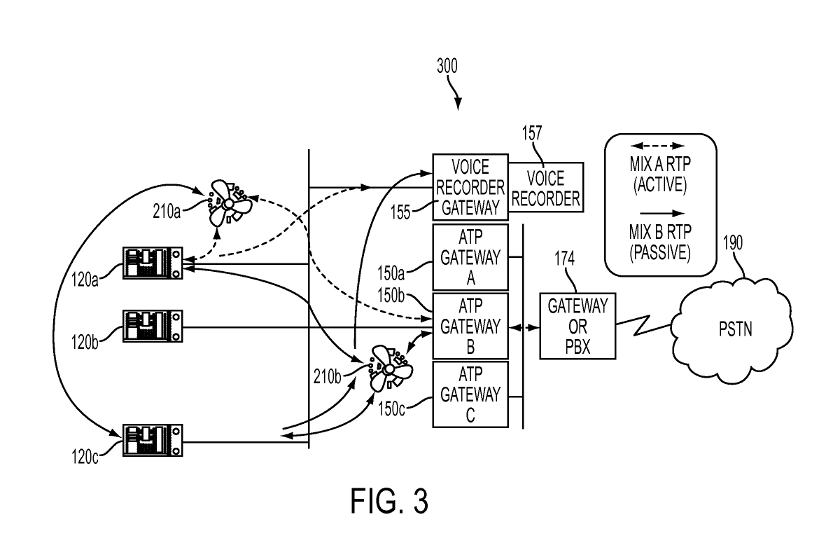

Referring now to FIG. 3, a conference system 300 is shown according to an exemplary embodiment of the present invention. The conference system 300 is similar to the conference system 200 except that the data stream flows may represent an outgoing call, from, for example, the terminal 120a. In an exemplary embodiment, data streams may be broadcast from the terminal 120a to terminal 120c participating in the conference and to endpoints in the PSTN 190. Data streams from terminals 120a and 120c may be primarily mixed by mixer 210a. Simultaneous redundant mixing of data streams from terminals 120a and 120c may be processed by back-up mixer 210b whose output data streams may be in passive mode until needed. In addition, mixed data streams, both primary and secondary may be provided to the voice recorder gateway 155 and stored in the voice recorder 157 for future playback.

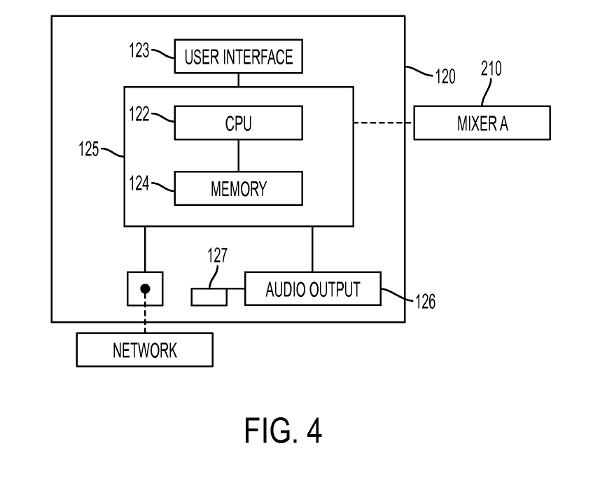

Referring now to FIG. 4, the terminal 120 may include a controller 121, a communication interface port 129 adapted to transmit and receive audio data signals, and a user interface 123. The controller 121 may include a processing device 122 (e.g. a processor or CPU) and memory 124 storing instructions configured for execution by the processing device 122. An audio output module 126 may provide the processed audio data to an output interface 127 (e.g. a speaker). It will be understood that in some embodiments, other endpoints in the system 100, for example servers 150 may use a similar configuration as shown for the terminal 120 and thus the processing device 122 may perform actions associated with exemplary embodiments of the present invention at any of the endpoints. The actions described above may be performed by the processing device 122 executing computer readable instructions unless otherwise noted. For example, the conversion of data stream formats from different sources into a session initiated protocol may be performed by the processing device 112. The processing device 122 may also manage which endpoints participate in a conference and which mixers 210 may mix the data streams during the conference according to the computer readable instructions.

One or more mixers 210 may be in communication with the terminal 120. The mixer 210 may be entirely software operating as a set of mixer instructions 128 in and/or between terminals 120 in the system 100. The set of mixer instructions 128 are shown as part of the mixer 210 however it will be understood that the set of instructions 128 may be resident within the controller 121 of respective terminals 120 in communication with each other. In an exemplary embodiment, the system 100 may include multiple mixers 210 available for any given teleconference convening within the system 100.

Referring to the Figures in general, the system 100 may include endpoints and servers running Linux and deployed as Linux appliances. The servers may operate on x86-based machines, may use PKI based security and be accessible via https interfaces for management, which may lock down the Linux appliance from a security perspective. The Linux appliance may also be deployed as a VMWare vmdk file or Xen img file.

One or more redundant physical servers may be operated. These may each be running a login server, an application server, and a management server possibly on virtual machines on each physical server. According to some exemplary embodiments, the servers may be deployed as physical Linux appliances in 1U servers or blade architectures.

A terminal 120 may terminate anywhere from 2 to 20 voice, video, or multimedia streams simultaneously. In addition, the terminal 120 may need to stream extra RTP streams to IP voice loggers. The terminal 120 may run acoustic echo cancellation and deal with other audio processing work such as wide bandwidth CODEC's, compression, volume control, and speaker muting, for example. The terminal 120 may run embedded Linux in the main CPU with digital signal processors (DSP's) attached for audio processing. The PBX phone type endpoints may require a similar audio processing as the terminal 120 above, but on a smaller scale. However, in order to leverage common software and features a PBX connected phone may run the same embedded Linux as the terminal 120, but on a smaller processor.

The system 100 servers may run embedded Linux consistent with the rest of the system 100 and may be managed via HTTPS. The core processing and digital signaling processor architecture in these servers may be similar to the digital signaling processor the terminal 120 and therefore common designs may be leveraged.

Gateway servers 150 may be session boundary controllers (SBCs) that may serve as local virtual proxy turrets for remote terminals 120 in the RTP mesh network 110. The audio mixing component for voice recording may be on the terminal 120, on gateways 150, on dedicated mixer servers, or on the voice recording server 155. The terminals 120 may download profiles from the ATP switch at boot or login.

It should be understood, of course, that the foregoing relates to exemplary embodiments of the invention and that modifications may be made without departing from the spirit and scope of the invention as set forth in the following claims.

What is claimed is:

1. A conferencing system, comprising:
a plurality of endpoints connected in a peer-to-peer relationship;
at least one mixer connected to the plurality of endpoints, configured to mix data streams from a plurality of participants in a conference;
a processing device in at least one of the plurality of endpoints configured to convert data streams from the plurality of endpoints into a real transport protocol.

2. The conferencing system of claim 1, wherein the plurality of endpoints are configured to provide more than one type of data stream.

3. The conferencing system of claim 2, wherein at least one of the plurality of endpoints is a virtual endpoint.

4. A conferencing system, comprising:
a plurality of terminals connected via a mesh network;
at least one gateway server coupled to the plurality of terminals and to a device connected into the network through a public switched telephone network (PSTN); and
a processor configured to convert data from the device into a data stream format readable by the plurality of terminals.

5. The conferencing system of claim 4, wherein a session initiated protocol is used on the data from the device as it is routed into the gateway server.

6. The conferencing system of claim 4, further comprising at least two data stream mixers coupled to the plurality of terminals configured to mix data streams from the plurality of terminals and from the gateway server.

7. A computer program product for connecting endpoints using a plurality of data stream formats into a conference, the computer program product comprising a non-transitory computer readable storage medium having program code embodied therewith, the program code readable/executable by a processing device to:
identify endpoints corresponding to participants on the conference;
identify a data format corresponding to respective devices used at the endpoints;
apply a data common protocol to data streams from each of the endpoints; and
distribute the data streams to respective endpoints through a mesh network connection of the endpoints.

8. The computer program product of claim 7, wherein the mesh network sends the data streams via a unicast transmission.

9. The computer program product of claim 7, the program code being readable and executable by the processor to mix data streams from the respective endpoints using a real-time transport protocol.
